(19) United States
(12) Patent Application Publication
(10) Pub. No.: US 2012/0063792 A1
(43) Pub. Date: Mar. 15, 2012

(54) IMAGE FORMING APPARATUS

(75) Inventor: Myung Won KIM, Suwon-si (KR)

(73) Assignee: Samsung Electronics Co., Ltd, Suwon-si (KR)

(21) Appl. No.: 13/225,972

(22) Filed: Sep. 6, 2011

(30) Foreign Application Priority Data
Sep. 9, 2010 (KR) 10-2010-0088628

(51) Int. Cl. G03G 15/08

(52) U.S. Cl. 399/27

(57) ABSTRACT

An image forming apparatus includes an internal memory provided in a microprocessor used to control general operations of the image forming apparatus. As the microprocessor records or reads lifespan information of replaceable elements, which are separably mounted in the image forming apparatus, in or from the internal memory, security with respect to the lifespan information of the replaceable elements is more effectively enhanced, which prevents fraudulent use of the replaceable elements.

### CROSS-REFERENCE TO RELATED APPLICATIONS

This application claims the benefit of Korean Patent Application No. 2010-0088628, filed on Sep. 9, 2010 in the Korean Intellectual Property Office, the disclosure of which is incorporated herein by reference in its entirety.

### BACKGROUND OF THE INVENTION

1. Field of the Invention

Embodiments of the present inventive concept relate to an image forming apparatus to prevent fraudulent use of replaceable elements separably mounted in a main body thereof.

2. Description of the Related Art

An image forming apparatus, such as printers, copiers, scanners, and devices combining functions thereof, contain replaceable elements.

A developer cartridge is one of the replaceable elements of the image forming apparatus. The developer cartridge may be classified into an initial developer cartridge which is assembled into the image forming apparatus during manufacturing, and a developer cartridge for sale which is separately purchased by a user.

To reduce material costs, the initial developer cartridge does not contain a Customer Replaceable Unit Monitoring (CRUM) memory in which encoded lifespan information of the initial developer cartridge, such as the usage of toner, is stored.

In the case of an image forming apparatus which is equipped with the initial developer cartridge having no CRUM memory, a user may continuously perform a printing operation by purchasing the developer cartridge for sale after a printing operation corresponding to the usage of toner received in the initial developer cartridge is performed.

Since the initial developer cartridge does not have the CRUM memory in which lifespan information is stored, the image forming apparatus executes a hard-stop operation to prevent the initial developer cartridge from outputting printed matter after the number of sheets of the printed matter exceeds a predetermined value. The hard-stop operation is, for example, executed if a page count, a dot count, a photoconductor operating time or a rotation time of a developing roller provided in the initial developer cartridge exceeds a preset threshold value.

Execution of the hard-stop operation may require storage of lifespan information of the initial developer cartridge in a main controller unit during printing. To this end, lifespan information of the initial developer cartridge has conventionally been stored in an Electrically Erasable Programmable Read Only Memory (EEPROM) as a nonvolatile memory of the main controller unit, to assist in managing the initial developer cartridge.

However, this may have a risk in that a hacker can steal the lifespan information when the EEPROM is removed from the main controller unit or when a Central Processing Unit (CPU) acts as a microprocessor to access data, hindering transmission of a normal data value using a kit made by the hacker.

For example, with relation to the fact that it may be necessary to store, e.g., a page count value and a dot count value in the EEPROM whenever a printing operation is performed, the kit may hinder ‘data writing’ to prevent storage of data in the EEPROM. Also, when it is checked whether or not the above mentioned value reaches a threshold value for the hard-stop operation, the kit may read a data value related to the hard-stop operation of the initial developer cartridge from the EEPROM and change the data value so as to transmit incorrect data to the CPU, which prevents the CPU from executing the hard-stop operation and consequently, causes the initial developer cartridge to continue a printing operation.

### SUMMARY OF THE INVENTION

The present general inventive concept provides an image forming apparatus to more effectively reinforce security with respect to lifespan information of replaceable elements thereof.

Additional features of the inventive concept will be set forth in part in the description which follows and, in part, will be obvious from the description, or may be learned by practice of the inventive concept.

Embodiments of the present general inventive concept provide an image forming apparatus having a replaceable element, including a microprocessor to control driving of the replaceable element, and a memory in which lifespan information of the replaceable element is recorded by the microprocessor, wherein the memory is provided within the microprocessor.

The replaceable element may be an initial developer cartridge.

The lifespan information of the initial developer cartridge may include at least one of quantity information of toner in the initial developer cartridge, toner consumption information, drive time information and count information of pages printed by the initial developer cartridge.

The memory may be a non-volatile memory.

The non-volatile memory may be an Electrically Erasable Programmable Read Only Memory (EEPROM).

The non-volatile memory may be a flash memory.

Embodiments of the present general inventive concept also provide an image forming apparatus having a replaceable element, including a microprocessor to control driving of the replaceable element, and an internal memory provided within the microprocessor, wherein the microprocessor records lifespan information of the replaceable element in the internal memory and controls implementation or stoppage of a printing operation based on the recorded information.

The replaceable element may be an initial developer cartridge.

The lifespan information of the initial developer cartridge may include at east one of quantity information of toner in the initial developer cartridge, toner consumption information, drive time information and count information of pages printed by the initial developer cartridge.

The microprocessor may read the lifespan information of the initial developer cartridge stored in the internal memory and rosy control implementation of the printing operation if a read lifespan value is a preset value or less, and may control stoppage of the printing operation if the read lifespan value exceeds the preset value.

The internal memory may be an EEPROM or a flash memory.

Embodiments of the present general inventive concept also provide an image forming apparatus having at least one replaceable element, including a microprocessor to control driving of the replaceable element, and a flash memory having a first region in which a program to drive the microprocessor is stored and a second region in which lifespan information of the replaceable element is stored, wherein the microprocessor records the lifespan information of the replaceable element in the second region of the flash memory.

Embodiments of the present general inventive concept also provide an image forming apparatus having at least one replaceable unit; and a microprocessor to control driving of the at least one replaceable unit and including an internal memory disposed therein in which lifespan information of the at least one replaceable unit is recorded by the microprocessor.

### BRIEF DESCRIPTION OF THE DRAWINGS

These and/or other features of the general inventive concept will become apparent and more readily appreciated from the following description of the embodiments, taken in conjunction with the accompanying drawings of which:

FIG. 1 is a sectional view illustrating a schematic configuration of an image forming apparatus in accordance with an embodiment of the present inventive concept;

FIG. 2 is a schematic control block diagram of the image forming apparatus in accordance with an embodiment of the present inventive concept;

FIG. 3 is a block diagram illustrating a configuration of an embodiment of a main controller unit provided in the image forming apparatus illustrated in FIG. 2;

FIG. 4 is a schematic block diagram illustrating an interior configuration of a CPU illustrated in FIG. 3;

FIG. 5 is a block diagram illustrating a configuration of another embodiment of the main controller unit provided in the image forming apparatus illustrated in FIG. 2;

FIG. 6 is a schematic block diagram illustrating an interior configuration of a CPU illustrated in FIG. 5;

FIG. 7 is a schematic control block diagram of an image forming apparatus in accordance with another embodiment of the present inventive concept; and

FIG. 8 is a block diagram illustrating an interior configuration of a main controller unit illustrated in FIG. 7.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

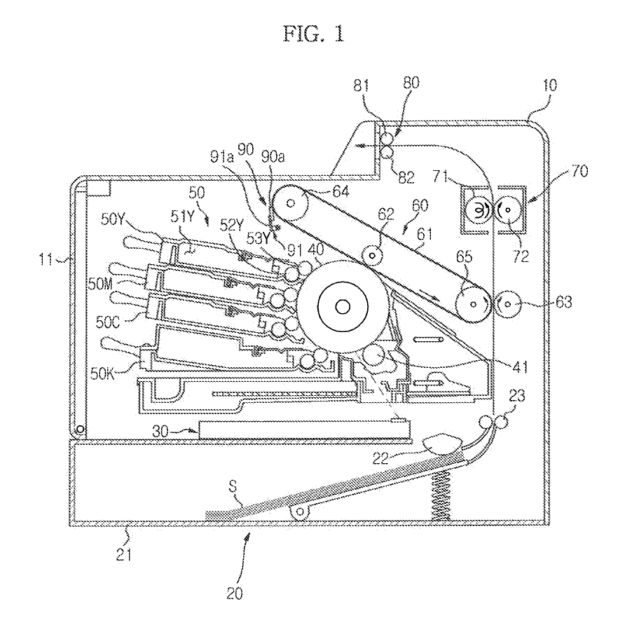

FIG. 1 is a sectional view illustrating a schematic configuration of an image forming apparatus in accordance with one embodiment of the present inventive concept;

As illustrated in FIG. 1, the image forming apparatus 1 includes a main body 10, a print media feeding device 20, a light scanning device 30, a photoconductor 40, a developing device 50, a transfer device 60, a fusing device 70 and a print media discharge device 80.

The main body 10 defines the external appearance of the image forming apparatus 1 and supports a variety of elements installed therein. A main body cover 11 is pivotally installed to one side of the main body 10. The main body cover 11 opens or closes a part of the main body 10.

The print media feeding device 20 feeds print media to the transfer device 60. The print media feeding device 20 includes a cassette 21 in which print media S is stored, a pickup roller 22 to pick up the print media S stored in the cassette 21 sheet by sheet, and a conveyance roller 23 to convey the picked-up print media to the transfer device 60.

The light scanning device 30 is located below the developing device 50 and irradiates light corresponding to image information to the photoconductor 40 to form an electrostatic latent image on a surface of the photoconductor 40.

The photoconductor 40 is configured such that a photo conductive layer is formed on the periphery of a cylindrical metallic drum. The photoconductor 40 is provided with an electrostatic latent image by the light scanning device 30 and developer images by the developing device 50. The photoconductor 40 is rotatably installed in the main body 10.

A charge roller 41 is installed in the main body 10. The charge roller 41 charges the photoconductor 40 with a predetermined electric potential before the light scanning device 30 irradiates light to the photoconductor 40.

The charge roller 41 is one example of a charger to charge the photoconductor 40 with an even electric potential. The charge roller 41 performs supply of electric charge while rotating in contact with or not in contact with an outer peripheral surface of the photoconductor 40. As an alternative to the charge roller 2, a corona discharger may be employed.

The developing device 50 forms a developer image by feeding developer to the photoconductor 40 on which the electrostatic latent image has been formed. The developing device 50 can include, four developing cartridges 50Y, 50M, 50C and 50K in which different colors of developers, for example, Yellow, Magenta, Cyan and Black developers are received respectively.

The developing cartridges SOY, 50M, 50C and 50K respectively include developer cartridges 51Y, 51M, 51C and 51K, feeding rollers 52Y 52M, 52C and 52K and developing rollers 53Y, 53M, 53C and 53K.

The developer cartridges 51Y, 51M, 51C and 51K store developers to be fed to the photoconductor 40.

The feeding rollers 52Y, 52M, 52C and 52K feed the developers stored in the developer cartridges 51Y, 51M, 51C and 51K to the developing rollers 53Y, 53M, 53C and 53K.

The developing rollers 53Y, 53M, 53C and 53K attach the developers to the surface of the photoconductor 40 on which the electrostatic latent image has been formed, to form developer images.

The transfer device 60 includes an intermediate transfer belt 61, a first transfer roller 62 and a second transfer roller 63.

The intermediate transfer belt 61 is an image carrier to carry the developer images formed by the developing device 50. The intermediate transfer belt 61 is supported by support rollers 64 and 65 and circulates at the same velocity as a linear velocity of the photoconductor 40. A length of the intermediate transfer belt 61 is equal to or greater than a length of the print media S of a maximum size used in the image forming apparatus.

The first transfer roller 62 is arranged to face the photoconductor 40 with the intermediate transfer belt 61 interposed therebetween to transfer the developer images formed on the photoconductor 40 to the intermediate transfer belt 61. To enable transfer of the developer images from the photoconductor 40 to the intermediate transfer belt 61, a first transfer bias voltage is applied to the first transfer roller 62. The first transfer bias voltage has a polarity opposite to that of the developer. If the first transfer bias voltage is applied to the first transfer roller 62, the respective developer images formed on the surface of the photoconductor 40 are transferred to and overlap one another on the intermediate transfer belt 61, to form a primary transfer image.

The second transfer roller 63 is arranged to face the support roller 65 with the intermediate transfer belt 61 interposed therebetween. The second transfer roller 63 is spaced apart from the intermediate transfer belt 61 while the developer images are being transferred from the photoconductor 40 to the intermediate transfer belt 61, but comes into contact with the intermediate transfer belt 61 at a predetermined contact pressure after the developer images of the photoconductor 40 are completely transferred to the intermediate transfer belt 61. When the second transfer roller 63 comes into contact with the intermediate transfer belt 61, the developer images on the intermediate transfer belt 61 are transferred to the print medium. A second transfer bias voltage to transfer the developer images to the print medium S is applied to the second transfer roller 63. The second transfer bias voltage has a polarity opposite to that of the developers. If the second transfer bias voltage is applied to the second transfer roller 63, the primary transfer image formed on the intermediate transfer belt 61 is transferred to the print medium S fed by the print media feeding device 20, to form a secondary transfer image on the print medium S.

The fusing device 70 includes a heating roller 71 having a heat source and a pressure roller 72 installed opposite the heating roller 71. When the printing medium passes between the heating roller 71 and the pressure roller 72, the image is fixed to the print medium by heat transferred from the heating roller 71 and pressure acting between the heating roller 71 and the pressure roller 72.

The print media discharge device 80 includes a discharge roller 81 and a discharge backup roller 82 to discharge the print medium having passed through the fusing device 70 to the outside of the main body 10.

The image forming apparatus 1 in accordance with the embodiment of the present inventive concept includes a cleaning unit 90 arranged to come into contact with the intermediate transfer belt 61 and a cleaning unit drive device 91 to pivotally rotate the cleaning unit 90.

The cleaning unit 90 includes a cleaning blade 90a to scrape waste developer remaining on a surface of the intermediate transfer belt 61 via friction with the intermediate transfer belt 61. The cleaning blade 90a can be made of an elastic material and scrapes the waste developer while coming into contact with the intermediate transfer belt 61. Instead of the cleaning unit 90 using the cleaning blade 90a, a brush type or roller type cleaning unit may be possible.

The cleaning unit drive device 91 rotates the cleaning unit 90 about a rotating shaft 91a thereof to separate the cleaning unit 90, which is in contact with the intermediate transfer belt 61, from the intermediate transfer belt 61.

Hereinafter, operation of the image forming apparatus having the above described configuration will be described in brief.

If a printing operation begins, the charge roller 41 charges the surface of the photoconductor 40 with an even electric potential. The light scanning device 30 irradiates light corresponding to information of any one color image, e.g., a yellow image, to the surface of the photoconductor 40, which has been evenly charged.

As a result of the scanning onto the charged surface of the photoconductor 40, an electrostatic latent image corresponding to the yellow image is formed on the photoconductor 40.

Subsequently, a developing bias voltage is applied to the developing roller 53 of the yellow developing cartridge 50Y, causing yellow developer to be attached to the electrostatic latent image and consequently, a yellow developer image is formed on the photoconductor 40. The developer image on the photoconductor 40 is then transferred to the intermediate transfer belt 61 by the first transfer roller 62.

Once the yellow image is completely transferred onto a sheet of the print medium from the transfer belt 61, the light scanning device 30 irradiates light corresponding to information of another color image, e.g., magenta image to the photoconductor 40, thus forming an electrostatic latent image corresponding to the magenta image. The magenta developing cartridge 50M feeds magenta developer to the electrostatic latent image to form a magenta developer image. The magenta developer image formed on the photoconductor 40 is transferred to the intermediate transfer belt 61 by the first transfer roller 62. In this case, the magenta developer image overlaps the previously transferred yellow developer image.

As the above described operation is repeated for cyan and black, a color image created by overlaying yellow, magenta, cyan and black upon one another is completed on the intermediate transfer belt 61. The completed color image is transferred to the print medium passing between the intermediate transfer belt 61 and the second transfer roller 63, and the print medium is discharged to the outside of the main body 10 by way of the fusing device 70 and the print media discharge device 80.

In the image forming apparatus in accordance with the present embodiment, replaceable elements are elements separably mounted in the main body of the image forming apparatus. The replaceable elements are replaceable when completely exhausted.

Examples of the replaceable elements may include the developing device, charge device, light scanning device, photoconductor, transfer device and fusing device. Other replaceable elements, which are necessary in the image forming apparatus and have possibility of replacement when in use, are not excluded. The replaceable elements may be realized in various manners.

Hereinafter, for convenience of description, the replaceable element is referred to as an initial developer cartridge 51 which is mounted in a product from a factory.

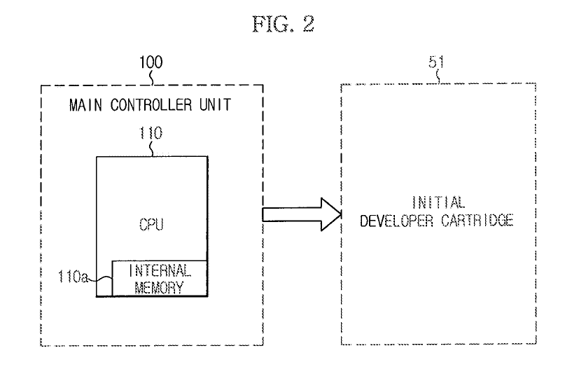

FIG. 2 is a schematic control block diagram of the image forming apparatus in accordance with the embodiment of FIG. 1.

As illustrated in FIG. 2, the image forming apparatus includes a main controller unit 100, which records lifespan information of the initial developer cartridge 51 therein and controls a printing operation based on the recorded lifespan information.

The main controller unit 100 is fixed in the main body 10 of the image forming apparatus.

The main controller unit 100 includes a CPU 110 as a microprocessor to control general operations of the image forming apparatus.

The CPU 110 includes an internal memory 110a to record and read lifespan information of the initial developer cartridge 51 as the initial developer cartridge 51 is used. In this case, the lifespan information of the initial developer cartridge 51 includes quantity information of toner in the initial developer cartridge 51, consumption information of the toner in the initial developer cartridge 51, actual drive time information of the initial developer cartridge 51 during printing, and count information of pages actually output by the initial developer cartridge 51.

Since the CPU 110 is generally a chip having several hundred pins, experts as well as general users have difficulty reprocessing and reattaching the chip, which may enhance security of the internal memory 110a.

As a result that the internal memory 110a storing the lifespan information of the initial developer cartridge 51 is integrated in the CPU 110, no data signal line is exposed to the outside, which may prevent hacking and enhance data security. More particularly, since the lifespan information of the initial developer cartridge 51 is recorded in the internal memory 110a of the CPU 110, hackers have difficulty accessing information stored in the internal memory 110a. Thus, data security is enhanced.

Moreover, the fact that a communication protocol, which records and reads data in the internal memory 110a of the CPU 110, is not open makes hacking more difficult, which may further enhance data security.

The CPU 110 has a control sequence programmed to encode the lifespan information of the initial developer cartridge 51 and store the encoded information in the internal memory 110a, in order to prevent hackers from determining a memory control operation using a kit. With this control sequence, the CPU 110 encodes the lifespan information of the initial developer cartridge 51 using an encoding algorithm and stores the encoded lifespan information in the internal memory 110a.

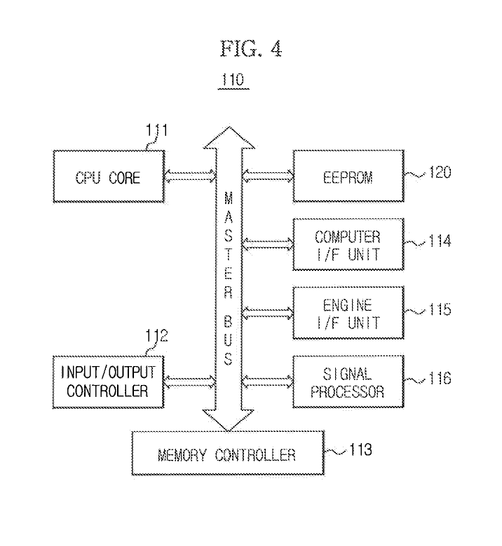

Thus, even if hackers install a hacking kit to the main controller unit 100, a microcomputer of the hacking kit cannot determine when a CPU core (see 111 in FIG. 4), which will be described hereinafter, and the internal memory 110a exchange data within the CPU 110, which prevents the hackers from stealing data and consequently, prevents fraudulent use of data.

In a mounted state of the initial developer cartridge 51, the CPU 110 performs recording the lifespan information of the initial developer cartridge 51 in the internal memory 110a at any one time from among the following: after forming a developer image on the photoconductor 40, after transferring the developer image to the intermediate transfer belt 61, prior to fusing the developer image transferred from the intermediate transfer belt 61 to a print medium, prior to completely ending the fusing operation, and after discharging the print medium to which the image has been fused. In addition, other times such as, for example, when 50% of the printing operation is performed, when 70% of the printing operation is performed, and during post-treatment after completion of the printing operation, are alternative options.

The CPU 110 may update the lifespan information of the initial developer cartridge 51, which has already been stored in the internal memory 110a by recording new lifespan information of the initial developer cartridge 51 in the internal memory 110a.

Since the initial developer cartridge 51 has no CRUM memory, a method of determining whether or not the initial developer cartridge 51 is mounted in a system includes applying a developing voltage to the developing roller 53 of the initial developer cartridge 51, sensing a voltage at a developing voltage output terminal, and determining that the initial developer cartridge 51 having no CRUM memory is mounted if the voltage is at a predetermined level or higher.

The CPU 110 reads the lifespan information of the initial developer cartridge 51 stored in the internal memory 110a. If a read lifespan value is within a threshold value of the lifespan of the initial developer cartridge 51, the CPU 110 operates the image forming apparatus to perform the printing operation.

On the other hand, if the read lifespan value exceeds the threshold value of the lifespan of the initial developer cartridge 51, the CPU 110 stops the printing operation of the image forming apparatus.

For example, the CPU 110 proceeds with the printing operation if a counted value of pages output from the initial developer cartridge 51 is within an allowable range, but stops the printing operation if the counted value exceeds the allowable range and simultaneously, outputs an associated message to allow a user to purchase a new developer cartridge.

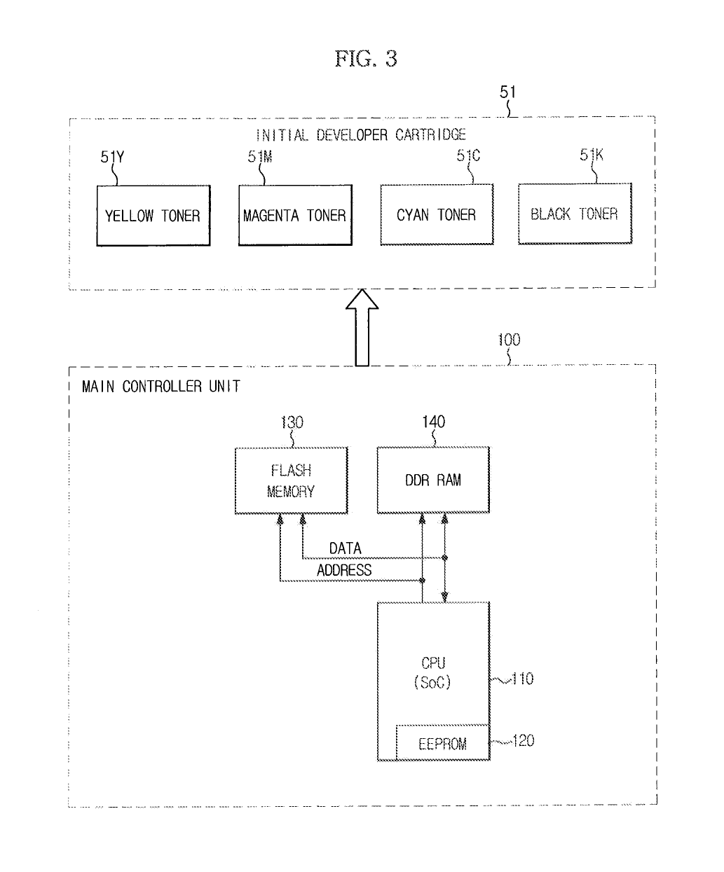

FIG. 3 is a block diagram illustrating a configuration of an embodiment of the main controller unit provided in the image forming apparatus illustrated in FIG. 2.

As illustrated in FIG. 3, the main controller unit 100 includes the CPU 110 containing an EEPROM 120 therein, a flash memory 130, and a Double Data Rate Random Access Memory (DDR RAM) 140.

The flash memory 130 is a non-volatile memory which functions to electrically erase data and again record new data. The flash memory 130 stores a variety of programs to drive the CPU 110 and the DDR RAM 140 and perform the printing operation.

The DDR RAM 140 temporarily stores a variety of data obtained by performing programs associated with the printing operation of the CPU 110 and a variety of data generated during data processing.

The CPU 110 is a System On Chip (SoC) in which the EEPROM 110 containing the lifespan information of the initial developer cartridge 51 is provided. In this case, the initial developer cartridge 51, for example, consists of four developer cartridges 51Y, 51M, 51C and 51K.

As Illustrated in FIG. 4, the CPU 110 includes the CPU core 111, an input/output controller 112, a memory controller 113, a computer I/F unit 114, an engine I/F unit 115, a signal processor 116 and the EEPROM 120.

The CPU core 111 controls general operations of the aforementioned respective elements.

The input/output controller 112 receives and outputs signals.

The memory controller 113 access the flash memory 130, the DDR RAM 140 and the EEPROM 120 in response to an access request of the CPU core 111 and controls data reading or writing. In this case, the CPU core 111 may directly access the EEPROM 120.

The computer I/F unit 114 serves as an interface for input/output of signals between a host computer connected to the image forming apparatus and the CPU core 111.

The engine I/F unit 115 serves as an interface for input/output of signals between the respective elements of the image forming apparatus (e.g., the developing device, charge device, light scanning device, photoconductor, transfer device and fusing device).

The signal processor 116 includes an Analog to Digital Converter (ADC), and a Digital to Analog Converter (DAC). The signal processor 116 converts analog signals into digital signals or vice versa to allow the CPU core 111 to exchange signals with other devices.

The respective elements of the CPU 110 exchange information via a Master Bus (MB).

The EEPROM 120 is a non-volatile memory with characteristics in that already stored data values are not erased even if system power of the image forming apparatus is turned off. Thus, the EEPROM 120 is a widely used memory device.

The CPU core 111 records the lifespan information of the initial developer cartridge 51, such as quantity information of toner in the initial developer cartridge 51, toner consumption information, actual drive time information of the initial developer cartridge 51 during printing, and count information of pages actually output by the initial developer cartridge 51, in the EEPROM 120.

Referring again to FIG. 3, at any one time after completion of a developing operation, transfer operation, fusing operation or printing operation, the CPU 110 encodes the lifespan information of the initial developer cartridge 51 using an encoding algorithm as the usage of the initial developer cartridge 51 proceeds and records the encoded lifespan information in the EEPROM 120.

As the lifespan information of the initial developer cartridge 51 is recorded in the EEPROM 120 of the CPU 110, hackers are prevented from accessing information stored in the EEPROM 120, resulting in enhanced data security.

Moreover, due to the absence of a communication protocol which records and reads data between the CPU core 111 and the EEPROM 120, data security may be further enhanced. More particularly, even if hackers install a hacking kit to the main controller unit 100, a microcomputer of the hacking kit cannot determine when the CPU core (see 111 in FIG. 4) and the internal memory 110a exchange data within the CPU 110, which prevents hackers from stealing data and consequently, prevents fraudulent use of data.

Since the EEPROM 120 is installed in the CPU 110, the EEPROM 120 may have a smaller size than a commercial non-volatile memory device.

In consideration of such a reduced memory capacity, only important values of the initial developer cartridge 51, e.g., a counted value of pages directly associated with the lifespan of the initial developer cartridge 51, may be stored in the EEPROM 120, whereas other general event log values and the like may be stored in another auxiliary memory, such as the flash memory 130. The CPU 110 may be designed to enable this divisional data storage.

The CPU 110 reads the lifespan information of the initial developer cartridge 51 stored in the EEPROM 120 during standby of the printing operation or during implementation of the printing operation, and determines that the initial developer cartridge 51 is usable if a read lifespan value is a preset value or less and operates the image forming apparatus. On the other hand, if the read lifespan value exceeds the preset value, the CPU 110 determines that the initial developer cartridge 51 is not usable and stops the printing operation of the image forming apparatus and simultaneously outputs an associated message to allow the user to purchase a new developer cartridge.

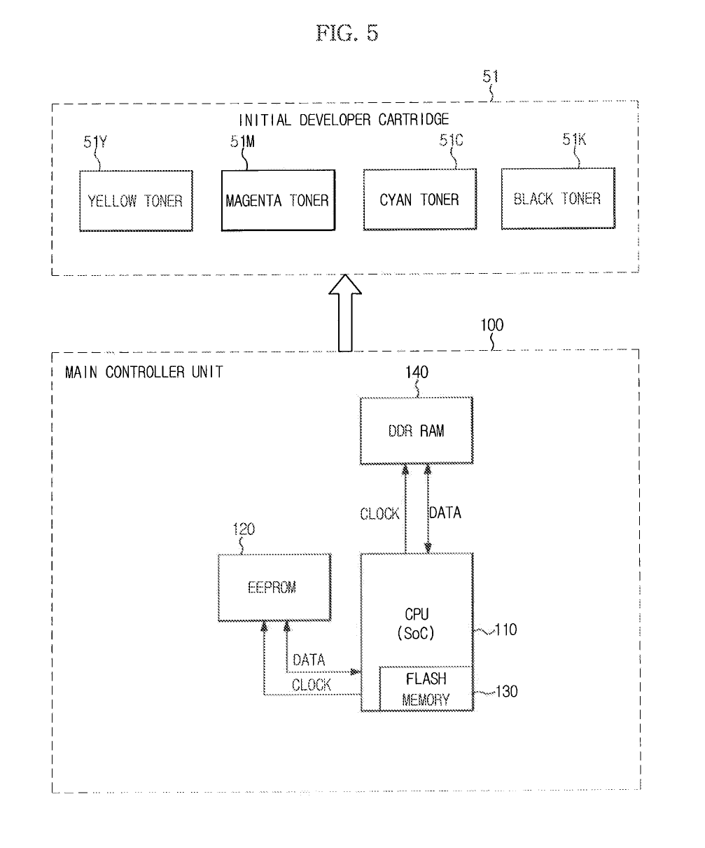

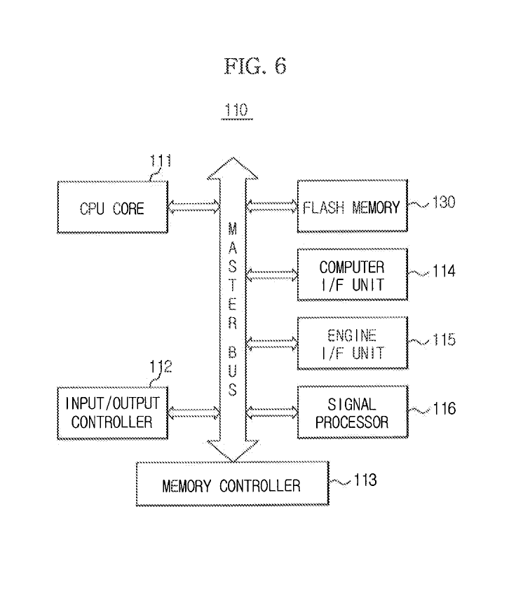

FIG. 5 is a block diagram illustrating a configuration of another embodiment of the main controller unit 100 provided in the image forming apparatus illustrated in FIG. 2. FIG. 6 is a schematic block diagram illustrating an interior configuration of the CPU 110 illustrated in FIG. 5.

As illustrated in FIGS. 5 and 6, the main controller unit 100 includes the CPU 110 containing the flash memory 130 therein, the EEPROM 120 and the DDR RAM 140.

The flash memory 130 is a non-volatile memory which functions to electrically erase data and again record new data. The flash memory 130 is divided into two storage regions, one of which stores a variety of programs to drive the CPU 110 and the DDR RAM 140 and perform a printing operation and the other one of which serves as a region in which the CPU core 111 of the CPU 110 records the lifespan information of the initial developer cartridge 51.

The CPU 110 is an SoC and is provided with the flash memory 130 having a lifespan information region 131 in which the lifespan information of the initial developer cartridge 51 is stored.

The CPU 110 includes the CPU core 111, the input/output controller 112, the memory controller 113, the computer I/F unit 114, the engine I/F Unit 115, the signal processor 116 and the flash memory 130.

The CPU core 111 records the lifespan information of the initial developer cartridge 51, such as quantity information of toner in the initial developer cartridge 51, toner consumption information, actual drive time information of the initial developer cartridge 51 during printing, and count information of pages actually output by the initial developer cartridge 51, in the lifespan information region 131 of the flash memory 130.

At any one time after completion of the developing operation, transfer operation, fusing operation or printing operation, the CPU 110 encodes the lifespan information of the initial developer cartridge 51 using an encoding algorithm as the usage of the initial developer cartridge 51 proceeds and records the encoded lifespan information in the flash memory 130.

In this case, the flash memory 130 is designed to perform data reading/writing on a per block basis. Therefore, to update the lifespan information of the initial developer cartridge 51 in real time, the CPU 110 stores the lifespan information of the initial developer cartridge 51 in the EEPROM 120 and thereafter, reads the stored lifespan information on a per block basis, thereby recording the information in the flash memory 130.

As described above, as the lifespan information of the initial developer cartridge 51 is recorded in the flash memory 130 of the CPU 110, hackers are prevented from accessing information stored in the flash memory 130, resulting in enhanced data security.

The CPU 110 reads the lifespan information of the initial developer cartridge 51 stored in the flash memory 130 during standby of the printing operation or during implementation of the printing operation, and determines that the initial developer cartridge 51 is usable if a read lifespan value is a preset value or less and operates the image forming apparatus.

On the other hand, if the CPU 110 reads the lifespan information of the initial developer cartridge 51 stored in the flash memory 130 and the read lifespan value exceeds the preset value, the CPU 110 determines that the initial developer cartridge 51 is not usable and stops the printing operation of the image forming apparatus and simultaneously outputs an associated message to allow the user to purchase a new developer cartridge.

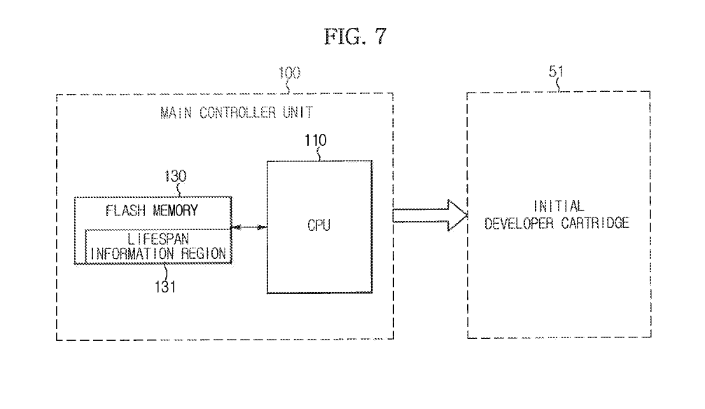

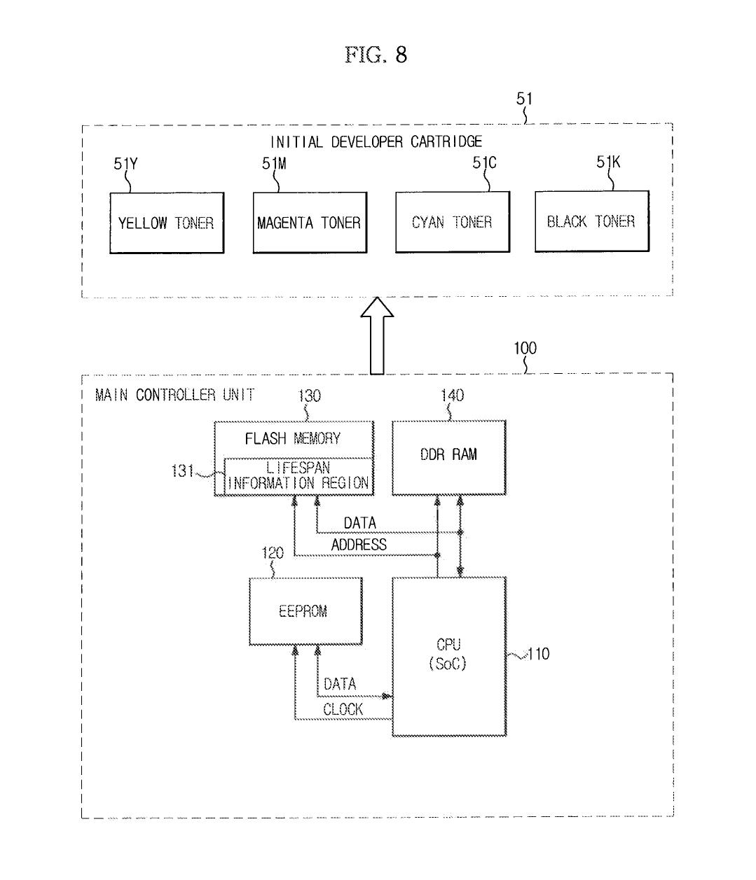

FIG. 7 is a schematic control block diagram of an image forming apparatus in accordance with another embodiment of the present inventive concept. FIG. 8 is a block diagram illustrating an interior configuration of a main controller unit 100 illustrated in FIG. 7.

As illustrated in FIGS. 7 and 8, a partial storage region of the flash memory 130 as a non-volatile memory within the main controller unit 100 may be configured to store the lifespan information of the initial developer cartridge 51. With this configuration, the lifespan information of the initial developer cartridge 51 may be stored in the flash memory 130 rather than the CPU 110.

Although the flash memory 130 may require a longer time to read or write data because data reading/writing is performed on a per block basis, the flash memory 130 has about 40 to 60 pins and is thus difficult to replace, exhibiting relatively enhanced data security.

As is apparent from the above description, according to the embodiments of the present inventive concept, lifespan information of replaceable elements is recorded in and read from an internal memory provided in a microprocessor that is used to control general operations of an image forming apparatus, which may effectively reinforce security with respect to the lifespan information of the replaceable elements and may prevent fraudulent use of the replaceable elements.

Although the embodiment of the present invention has been shown and described, it would be appreciated by those skilled in the art that changes may be made in these embodiments without departing from the principles and spirit of the invention, the scope of which is defined in the claims and their equivalents.

What is claimed is:

1. An image forming apparatus having a replaceable element, comprising:
a microprocessor to control driving of the replaceable element; and
a memory in which lifespan information of the replaceable element is recorded by the microprocessor,
wherein the memory is provided within the microprocessor.

2. The apparatus according to claim 1, wherein the replaceable element is an initial developer cartridge.

3. The apparatus according to claim 2, wherein the lifespan information of the initial developer cartridge includes at least one of quantity information of toner in the initial developer cartridge, toner consumption information, drive time information and count information of pages printed by the initial developer cartridge.

4. The apparatus according to claim 1, wherein the memory is a non-volatile memory.

5. The apparatus according to claim 4, wherein the non-volatile memory is an Electrically Erasable Programmable Read Only Memory (EEPROM).

6. The apparatus according to claim 4, wherein the non-volatile memory is a flash memory.

7. An image forming apparatus having a replaceable element, comprising:
a microprocessor to control driving of the replaceable element; and
an internal memory provided within the microprocessor,
wherein the microprocessor records lifespan information of the replaceable element in the internal memory and controls implementation or stoppage of a printing operation based on the recorded information.

8. The apparatus according to claim 7, wherein the replaceable element is an initial developer cartridge.

9. The apparatus according to claim 8, wherein the lifespan information of the initial developer cartridge includes at least one of quantity information of toner in the initial developer cartridge, toner consumption information, drive time information and count information of pages printed by the initial developer cartridge.

10. The apparatus according to claim 8, wherein the microprocessor reads the lifespan information of the initial developer cartridge stored in the internal memory and controls implementation of the printing operation if a read lifespan value is a preset value or less, and controls stoppage of the printing operation if the read lifespan value exceeds the preset value.

11. The apparatus according to claim 7, wherein the internal memory is an EEPROM or a flash memory.

12. An image forming apparatus having a replaceable element, comprising:
a microprocessor to control driving of the replaceable element; and
a flash memory having a first region in which a program to drive the microprocessor is stored and a second region in which lifespan information of the replaceable element is stored,
wherein the microprocessor records the lifespan information of the replaceable element in the second region of the flash memory.

13. An image forming apparatus, comprising:
at least one replaceable unit; and
a microprocessor to control driving of the at least one replaceable unit and including an internal memory disposed therein in which lifespan information of the at least one replaceable unit is recorded by the microprocessor.

14. The image forming apparatus of claim 13, wherein the microprocessor includes a control sequence programmed to encode the lifespan information of the initial at least one replaceable unit before recording the lifespan information in the internal memory.

15. The image forming apparatus of claim 14, wherein the microprocessor encodes the lifespan information of the initial at least one replaceable unit using an encoding algorithm.

16. The image forming apparatus of claim 14, wherein the microprocessor performs recording the lifespan information in the internal memory at any one time from among the following: after forming a developer image on a photoconductor, after transferring a developer image to an intermediate transfer belt, prior to fusing a developer image transferred from an intermediate transfer belt to a print medium, prior to completely ending a fusing operation, and after discharging a print medium to which an image has been fused.

17. The image forming apparatus of claim 13, wherein the at least one replaceable unit comprises a developer cartridge, and the microprocessor compares the lifespan information stored in the internal memory by the microcontroller to a threshold value to determine whether to operate the image forming apparatus to perform a printing operation.

18. The image forming apparatus of claim 17, wherein the lifespan information of the developer cartridge includes at least one of quantity information of toner in the initial developer cartridge, toner consumption information, drive time information and count information of pages printed by the initial developer cartridge.

19. The image forming apparatus of claim 13, wherein the internal memory is a flash memory.

20. The image forming apparatus of claim 19, wherein the flash memory comprises two divided storage regions, one which stores a variety of programs to drive the microprocessor and perform a printing operation and another region in which the microprocessor records the lifespan information.

21. The image forming apparatus of claim 13, wherein the internal memory is an EEPROM.
